(19) United States
(12) Patent Application Publication
(10) Pub. No.: US 2025/0219303 A1
(43) Pub. Date: Jul. 3, 2025

(54) NFC DEVICE AND IMPLEMENTING METHOD THEREOF

(71) Applicant: NXP B.V., Eindhoven (NL)

(72) Inventors: Kyriakos Neophytou, Graz (AT); Dorian Haslinger, Graz (AT)

(21) Appl. No.: 19/008,455

(22) Filed: Jan. 2, 2025

(30) Foreign Application Priority Data
Jan. 2, 2024 (EP) 24150081.8

(51) Int. Cl. H01Q 23/00; H01Q 7/00; H02J 50/23; H02J 50/40; H04B 5/79

(52) U.S. Cl. CPC H01Q 23/00; H01Q 7/00; H02J 50/23; H02J 50/40; H04B 5/79

(57) ABSTRACT

A near field communication (NFC) device includes two concentric NFC antennae. The first NFC antenna forms a first loop the second NFC antenna forms a second loop of the antenna. The overall electric and magnetic field patterns of the antenna can be controlled by changing the phase of signals used to drive the two antennae. In one configuration, the magnetic field strength may be concentrated toward a central area between the two antennae in a configuration suitable for transmitting conventional NFC signals. In another configuration the two antennae are driven with signals that are out of phase, resulting in a magnetic field pattern which extends over a wider area that is suitable for wireless device charging.

### CROSS-REFERENCE TO RELATED APPLICATIONS

This application claims priority under 35 U.S.C. § 119 to European patent application no. 24150081.8, filed Jan. 2, 2024, the contents of which are incorporated by reference herein.

### TECHNICAL FIELD

The present disclosure relates to a near field communication (NFC) device. Furthermore, the present disclosure relates to a corresponding method of implementing an NFC device.

### BACKGROUND

NFC devices for wireless charging applications face different challenges than NFC devices for typical NFC applications, such as contactless transactions. More specifically, the antennas of NFC devices for wireless charging applications should cover a larger area than the antennas of NFC devices for typical NFC applications. In practice, it may difficult to realize that these antennas cover a larger area.

### SUMMARY

In accordance with a first aspect of the present disclosure, a near field communication (NFC) device is provided, comprising: an antenna arrangement comprising a first NFC antenna and a second NFC antenna, wherein the first NFC antenna forms a first loop of the antenna arrangement and wherein the second NFC antenna forms a second loop of the antenna arrangement; a first transmitter operatively coupled to the first NFC antenna, wherein the first transmitter is configured to feed said first NFC antenna; a second transmitter operatively coupled to the second NFC antenna, wherein the second transmitter is configured to feed said second NFC antenna.

In one or more embodiments, the first loop is an outer loop of the antenna arrangement and the second loop is an inner loop of the antenna arrangement.

In one or more embodiments, the first NFC antenna is physically separated from the second NFC antenna.

In one or more embodiments, the first NFC antenna and the second NFC antenna are single-ended antennas.

In one or more embodiments, the NFC device is configured to operate in a first operating state and in a second operating state, wherein: in the first operating state, the first transmitter feeds the first NFC antenna with a first signal and the second transmitter feeds the second NFC antenna with a second signal, wherein a phase of the first signal is substantially the same as a phase of the second signal; in the second operating state, the first transmitter feeds the first NFC antenna with a third signal and the second transmitter feeds the second NFC antenna with a fourth signal, wherein a phase of the third signal is substantially different from a phase of the fourth signal.

In one or more embodiments, the difference between the phase of the third signal and the phase of the fourth signal is 180 degrees or approximately 180 degrees.

In one or more embodiments, the NFC device is configured to periodically switch between the first operating state and the second operating state.

In one or more embodiments, a charging device comprises the NFC device of any preceding claim.

In one or more embodiments, the charging device is a Qi-based charging device.

In accordance with a second aspect of the present disclosure, a method of implementing a near field communication (NFC) device is conceived, comprising: providing the NFC device with an antenna arrangement, wherein said antenna arrangement comprises a first NFC antenna and a second NFC antenna, wherein the first NFC antenna forms a first loop of the antenna arrangement and wherein the second NFC antenna forms a second loop of the antenna arrangement; providing the NFC device with a first transmitter operatively coupled to the first NFC antenna, wherein the first transmitter is configured to feed said first NFC antenna; providing the NFC device with a second transmitter operatively coupled to the second NFC antenna, wherein the second transmitter is configured to feed said second NFC antenna.

In one or more embodiments, the first loop is an outer loop of the antenna arrangement and the second loop is an inner loop of the antenna arrangement.

In one or more embodiments, the first NFC antenna is physically separated from the second NFC antenna.

In one or more embodiments, the first NFC antenna and the second NFC antenna are single-ended antennas.

In one or more embodiments, the method further comprises configuring the NFC device to operate in a first operating state and in a second operating state, wherein: in the first operating state, the first transmitter feeds the first NFC antenna with a first signal and the second transmitter feeds the second NFC antenna with a second signal, wherein the phase of the first signal is substantially the same as the phase of the second signal; in the second operating state, the first transmitter feeds the first NFC antenna with a third signal and the second transmitter feeds the second NFC antenna with a fourth signal, wherein the phase of the third signal is substantially different from the phase of the fourth signal.

In one or more embodiments, the difference between the phase of the third signal and the phase of the fourth signal is 180 degrees or approximately 180 degrees.

### DESCRIPTION OF DRAWINGS

Embodiments will be described in more detail with reference to the appended drawings.

FIG. 1 shows an example of an NFC device.

FIG. 2 shows an antenna performance.

FIG. 3 shows magnetic field measurements.

FIG. 4 shows an illustrative embodiment of an NFC device.

FIG. 5 shows an illustrative embodiment of a method of implementing an NFC device.

FIG. 6A shows an illustrative embodiment of an NFC device operating in a first operating state.

FIG. 6B shows an illustrative embodiment of an NFC device operating in a second operating state.

FIG. 7A shows an antenna arrangement performance in the first operating state.

FIG. 7B shows an antenna arrangement performance in the second operating state.

FIG. 8A shows magnetic field measurements in the first operating state.

FIG. 8B shows magnetic field measurements in the second operating state.

FIG. 9 shows an example implementation of an NFC device.

FIG. 10 shows a practical implementation of an NFC device.

### DESCRIPTION OF EMBODIMENTS

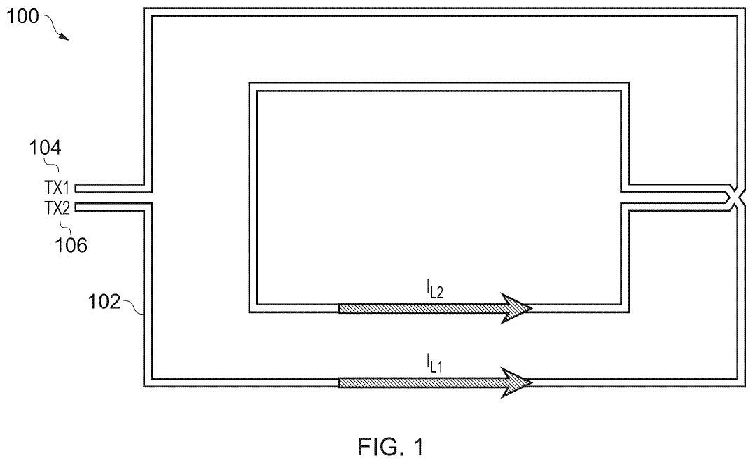

FIG. 1 shows an example of an NFC device 100. The NFC device comprises an NFC antenna 102, a first transmitter 104 operatively coupled to one end of the NFC antenna 102, and a second transmitter 106 operatively coupled to a second end of the NFC antenna 102. As mentioned above, NFC devices for wireless charging applications face different challenges than NFC devices for typical NFC applications. More specifically, the antennas of NFC devices for wireless charging applications should cover a larger area than the antennas of NFC devices for typical NFC applications. In practice, it may difficult to realize that these antennas cover a larger area. For example, NFC antennas for Qi-based charger designs having a so-called NFC card protection function should cover a larger area than typical NFC reader-oriented applications. However, a relatively large size of the antenna can result in a weak magnetic field at its center. Therefore, an inner loop is often added to the antenna. In the example shown in FIG. 1, the NFC antenna 102 includes an inner loop and an outer loop which are connected to each other, thereby forming a single antenna which covers a larger area than an antenna without an inner loop. By providing the NFC antenna 102 with an inner loop the magnetic field flowing through the center of the NFC antenna 102 can effectively be increased. However, the antenna design shown in FIG. 1 may suffer from a reduced magnetic field between the two loops. This is caused by the orientation of the current flowing through the two loops, which may result in destructive interference of the magnetic fields between the two loops. As a consequence, the magnetic field of the NFC antenna 102 as a whole may become non-uniform, which may result in a poor performance of the NFC device 100.

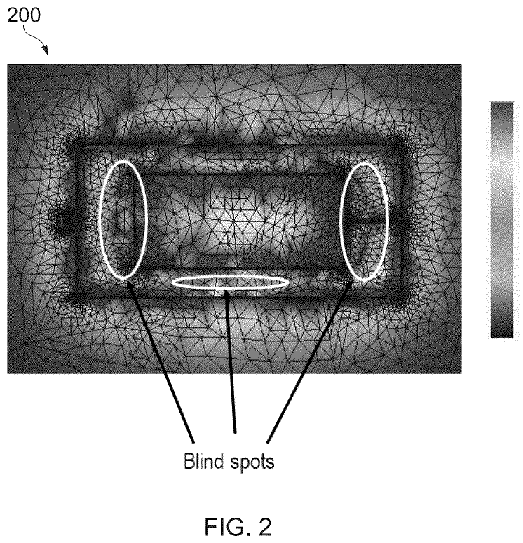

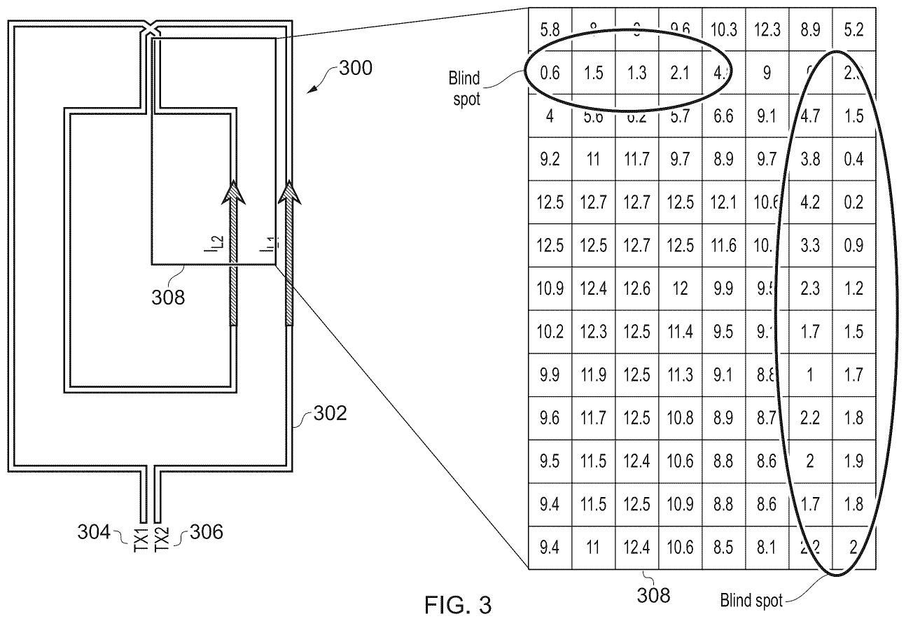

FIGS. 2 and 3 show the performance 200 of the NFC antenna shown in FIG. 1, respectively magnetic field measurements 300 performed on a specific area covered by this antenna, which are indicative of said performance. It is noted that the magnetic field measurements in the measurement area 308 are expressed in Volts (V). NFC antennas with a large aperture size may suffer from a weak magnetic field flowing through their center. As a result, detecting a phone or a tag with small sized NFC antennas placed in this center may be challenging. To improve the detection capability, one or more inner loops may be placed close to the center of the antenna, as shown in FIG. 1. Using the law of Biot-Savart, the magnetic field of such a structure may be analyzed. The current flow of the two loops have the same direction, which results in a constructive interference at the center of the antenna. However, the magnetic field between the loops may also suffer from destructive interference, thus resulting in a weak field (i.e., blind spots) between the two loops. This, in turn, may reduce the capability to communicate with a phone or a tag at the edges of the antenna.

Now discussed are an NFC device and a corresponding method of implementing an NFC device, which facilitate increasing the performance of said NFC device, in particular by producing a more uniform magnetic field.

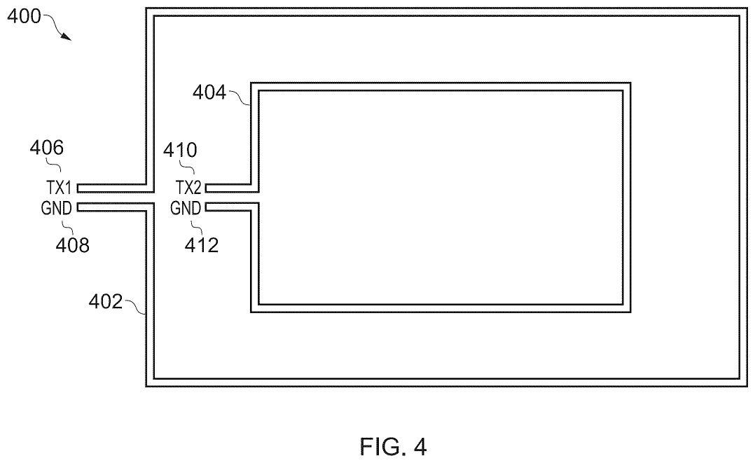

FIG. 4 shows an illustrative embodiment of an NFC device 400. The NFC device 400 comprises an antenna arrangement, which in turn comprises a first NFC antenna 402 and a second NFC antenna 404. The first NFC antenna 402 forms a first loop of the antenna arrangement. Furthermore, the second NFC antenna 404 forms a second loop of the antenna arrangement. In addition, the NFC device 400 comprises a first transmitter 406 operatively coupled to the first NFC antenna 402, wherein the first transmitter 406 is configured to feed said first NFC antenna 402. Furthermore, the NFC device 400 comprises a second transmitter 410 operatively coupled to the second NFC antenna 404, wherein the second transmitter 410 is configured to feed said second NFC antenna 404. By providing the NFC device 400 with an antenna arrangement having two separate loops formed by the first and second NFC antenna 402, 404, and feeding said separate loops through different transmitters 406, 410, the NFC device 400 may produce a more uniform magnetic field. In a practical implementation, the first transmitter 406 is operatively coupled to one end of the first NFC antenna 402, while the other end of said NFC antenna 402 is coupled to ground 408. Furthermore, in a practical implementation, the second transmitter 410 is operatively coupled to one end of the second NFC antenna 404, while the other end of said NFC antenna 404 is coupled to ground 412.

In one or more embodiments, the first loop is an outer loop of the antenna arrangement and the second loop is an inner loop of the antenna arrangement. In this way, it is facilitated that the NFC device produces a more uniform magnetic field. In one or more embodiments, the first NFC antenna is physically separated from the second NFC antenna. In this way, it is further facilitated that the NFC device produces a more uniform magnetic field. In a practical implementation, the first NFC antenna and the second NFC antenna are single-ended antennas.

In one or more embodiments, the NFC device is configured to operate in a first operating state and in a second operating state, wherein: in the first operating state, the first transmitter feeds the first NFC antenna with a first signal and the second transmitter feeds the second NFC antenna with a second signal, wherein the phase of the first signal is substantially the same as the phase of the second signal; in the second operating state, the first transmitter feeds the first NFC antenna with a third signal and the second transmitter feeds the second NFC antenna with a fourth signal, wherein the phase of the third signal is substantially different from the phase of the fourth signal. In this way, it is further facilitated that the NFC device produces a more uniform magnetic field. In particular, by alternating between the first operating state and the second operating state, a more uniform magnetic field may be obtained. In a practical implementation, the difference between the phase of the third signal and the phase of the fourth signal is 180 degrees or approximately 180 degrees. Furthermore, in a practical implementation, the NFC device is configured to periodically switch between the first operating state and the second operating state. The presently disclosed NFC device may be used to advantage in a charging device, for example in a Qi-based charging device.

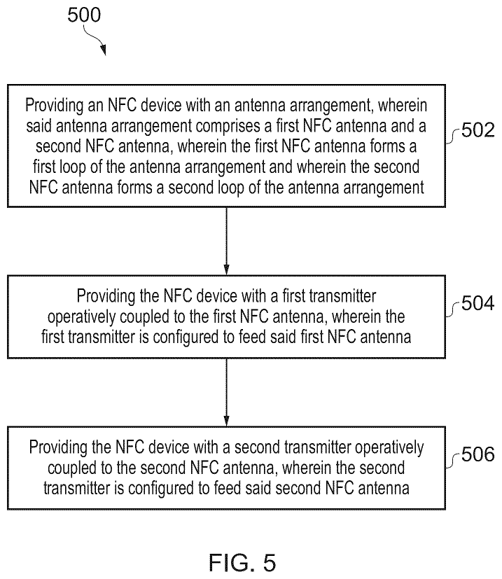

FIG. 5 shows an illustrative embodiment of a method 500 of implementing an NFC device. The method 500 comprises the following steps. At 502, the NFC device is provided with an antenna arrangement, wherein said antenna arrangement comprises a first NFC antenna and a second NFC antenna, wherein the first NFC antenna forms a first loop of the antenna arrangement and wherein the second NFC antenna forms a second loop of the antenna arrangement. At 504, the NFC device is provided with a first transmitter operatively coupled to the first NFC antenna, wherein the first transmitter is configured to feed said first NFC antenna. Furthermore, at 506, the NFC device is provided with a second transmitter operatively coupled to the second NFC antenna, wherein the second transmitter is configured to feed said second NFC antenna. As mentioned above, by providing the NFC device with an antenna arrangement having two separate loops formed by the first and second NFC antenna, and feeding said separate loops through different transmitters, the NFC device may produce a more uniform magnetic field.

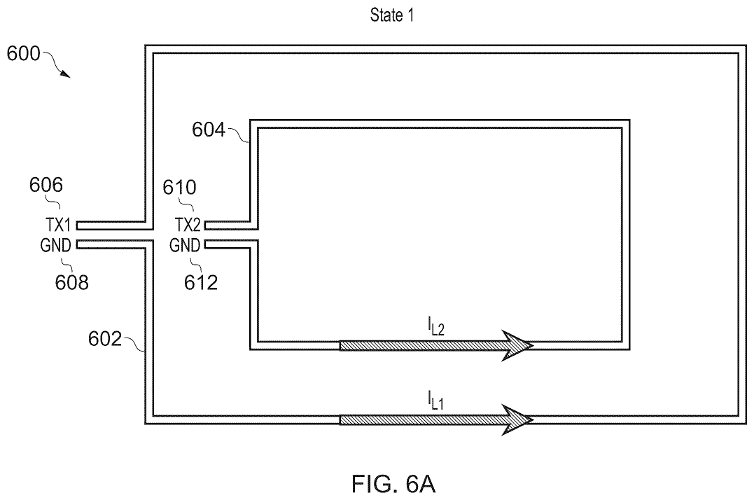

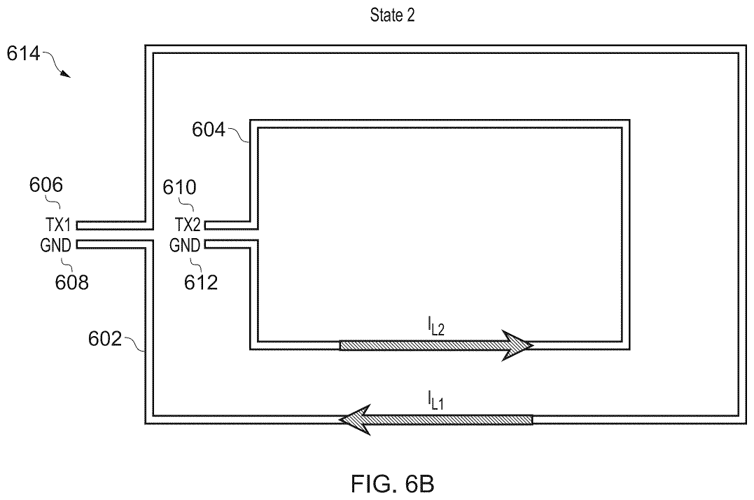

FIGS. 6A and 6B show an illustrative embodiment of an NFC device operating in a first operating state 600 and in a second state 614, respectively. The NFC device comprises two separated antenna loops, which are fed by two separated transmitters. Furthermore, each antenna is connected to a single-ended source and is thus not differential. By changing the phase difference between the two antennas, for example between in-phase (0° phase difference) and out-phase (180° phase difference), two different operating states can be achieved. When the two antennas are fed in-phase, the magnetic field produced by the two antennas results in constructive interference in the center. When the two antennas are fed out-phase, the magnetic field produced by the two antennas results in constructive interference between the two loops (i.e., at the edge of the antenna arrangement). By alternating between these two operating states (e.g., by periodically switching between the states) a uniform magnetic field can be achieved throughout the whole area covered by the antenna arrangement.

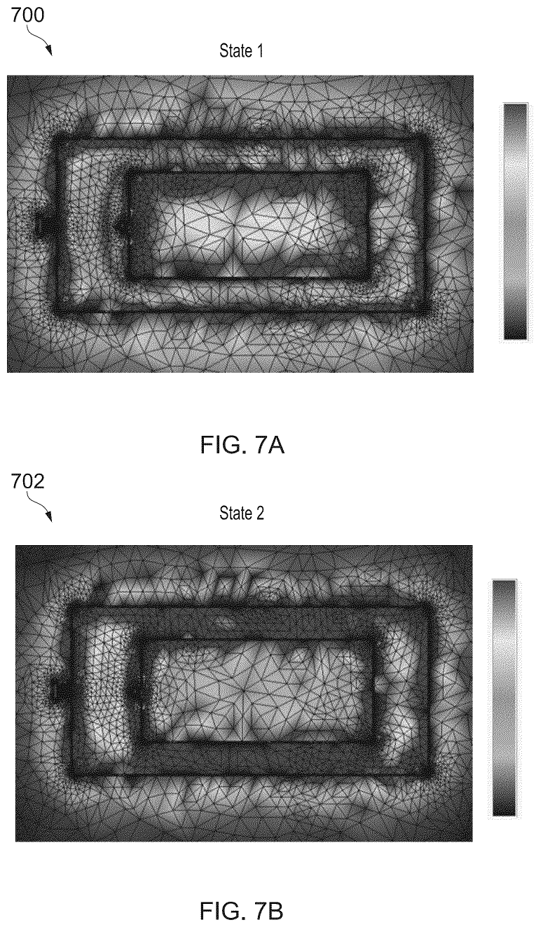

FIGS. 7A and 7B show an antenna arrangement performance 700 in the first operating state 700 and in the second operating state 702, respectively. In particular, the performance is shown of an antenna arrangement having two separated antenna loops, which are fed by two separated transmitters, in accordance with the present disclosure. In the first operating state, the center of the antenna arrangement is covered, while in the second operating state the edge of the antenna arrangement is covered (i.e., the area between the two loops). As mentioned above, by alternating between the two operating states a uniform magnetic field can be achieved throughout the whole area covered by the antenna arrangement.

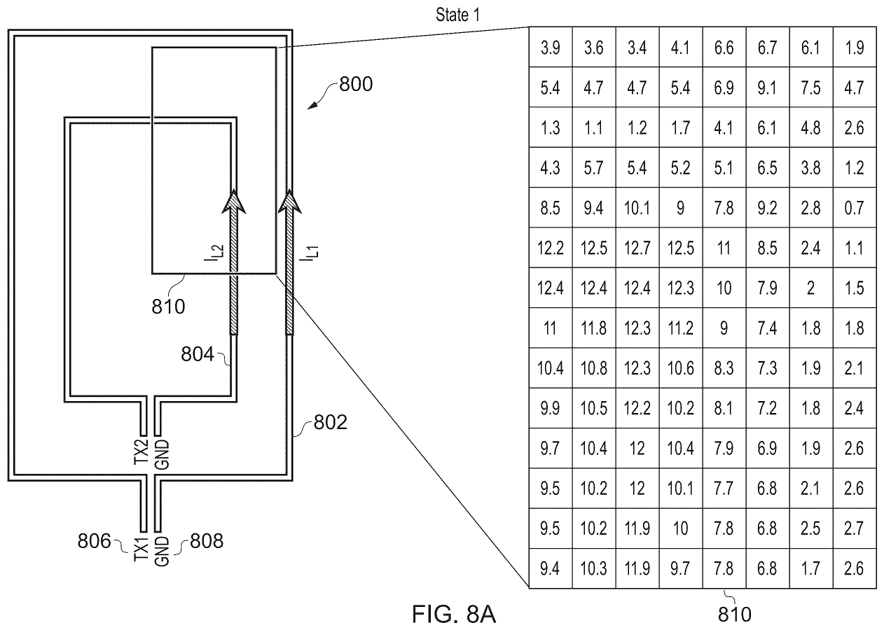

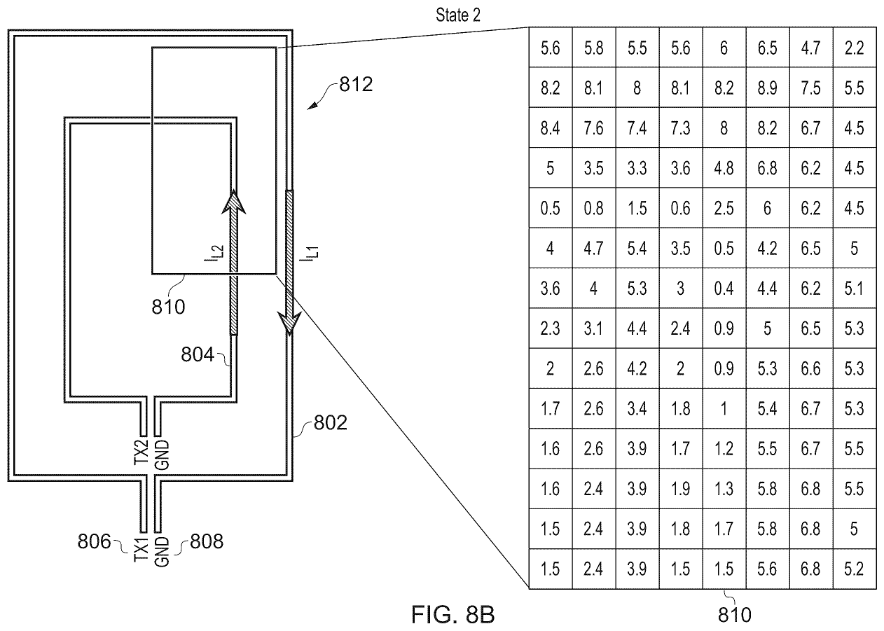

FIGS. 8A and 8B show magnetic field measurements in the first operating state 800 and in the second operating state 812, respectively. In particular, magnetic field measurements are shown of an antenna arrangement having two separated antenna loops, which are fed by two separated transmitters, in accordance with the present disclosure. It is noted that the magnetic field measurements in the measurement area 810 are expressed in Volts (V). By alternating between the two operating states the magnetic field throughout the whole area covered by the antenna arrangement may become more homogeneous.

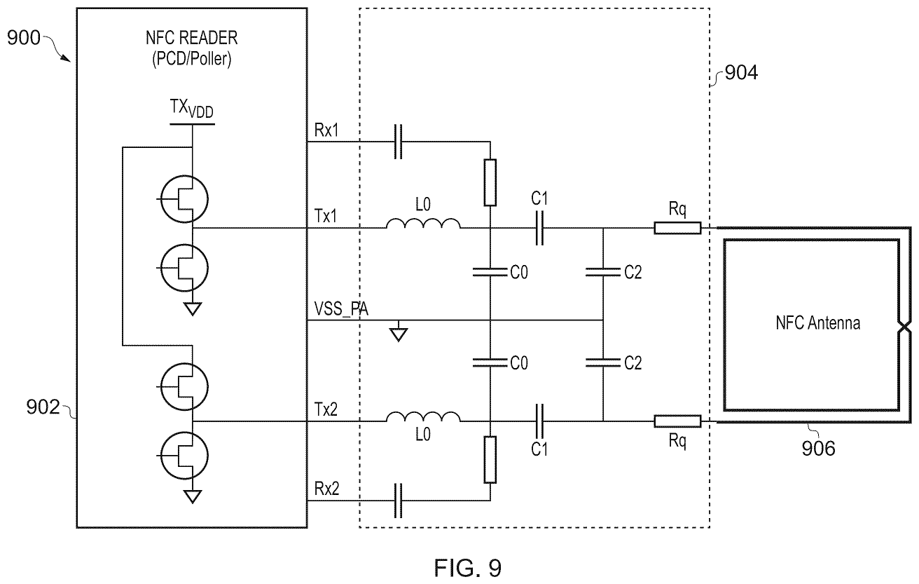

FIG. 9 shows an example implementation of an NFC device 900. In particular, a typical implementation of an NFC device used for wireless charging applications is shown. The NFC device 900 comprises an NFC reader integrated circuit (IC) 902, which is operatively coupled to an NFC antenna 906 through a matching circuit 904. As explained with reference to FIG. 1, the NFC antenna 906 includes an inner loop and an outer loop which are connected to each other, thereby forming a single antenna which covers a larger area than an antenna without an inner loop. In particular, the NFC antenna 906 is a differential antenna, more specifically an antenna which is fed differentially by two separate transmitters. As mentioned with reference to FIG. 1 above, such a design may suffer from a reduced magnetic field between the two loops. This is caused by the orientation of the current flowing through the two loops, which may result in destructive interference of the magnetic fields between the two loops. As a consequence, the magnetic field of the NFC antenna 906 as a whole may become non-uniform, which may result in a poor performance of the NFC device 900.

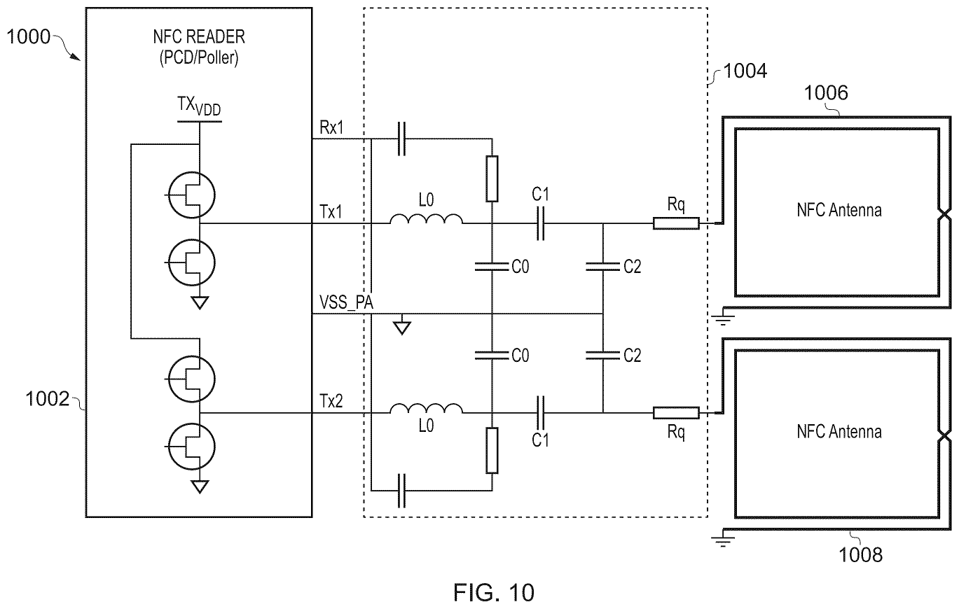

FIG. 10 shows a practical implementation of an NFC device 1000. In particular, a possible implementation is shown of an NFC device in accordance with the present disclosure. The NFC device 1000 comprises an NFC reader IC 1002, which is operatively coupled to separate NFC antennas 1006, 1008 through a matching circuit 1004. More specifically, the NFC antennas 1006, 1008 form separate loops of an antenna arrangement included in the NFC device 1000. In this case, the two separate transmitters are used to feed two single-ended NFC antennas 1006, 1008. The two transmitters can be controlled separately, which enables a precise control of the phase difference between them. Therefore, in-phase and out-phase operating states can easily be realized using such implementation.

It is noted that the embodiments above have been described with reference to different subject-matters. In particular, some embodiments may have been described with reference to method-type claims whereas other embodiments may have been described with reference to apparatus-type claims. However, a person skilled in the art will gather from the above that, unless otherwise indicated, in addition to any combination of features belonging to one type of subject-matter also any combination of features relating to different subject-matters, in particular a combination of features of the method-type claims and features of the apparatus-type claims, is considered to be disclosed with this document.

Furthermore, it is noted that the drawings are schematic. In different drawings, similar or identical elements are provided with the same reference signs. Furthermore, it is noted that in an effort to provide a concise description of the illustrative embodiments, implementation details which fall into the customary practice of the skilled person may not have been described. It should be appreciated that in the development of any such implementation, as in any engineering or design project, numerous implementation-specific decisions must be made in order to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill.

Finally, it is noted that the skilled person will be able to design many alternative embodiments without departing from the scope of the appended claims. In the claims, any reference sign placed between parentheses shall not be construed as limiting the claim. The word “comprise(s)” or “comprising” does not exclude the presence of elements or steps other than those listed in a claim. The word “a” or “an” preceding an element does not exclude the presence of a plurality of such elements. Measures recited in the claims may be implemented by means of hardware comprising several distinct elements and/or by means of a suitably programmed processor. In a device claim enumerating several means, several of these means may be embodied by one and the same item of hardware. The mere fact that certain measures are recited in mutually different dependent claims does not indicate that a combination of these measures cannot be used to advantage.

### LIST OF REFERENCE SIGNS

100 NFC device
102 NFC antenna
104 first transmitter
106 second transmitter
200 antenna performance
300 magnetic field measurements
302 NFC antenna
304 first transmitter
306 second transmitter
308 measurement area
400 NFC device
402 first NFC antenna
404 second NFC antenna
406 first transmitter
408 ground
410 second transmitter
412 ground
500 method of implementing an NFC device
502 providing an NFC device with an antenna arrangement, wherein said antenna arrangement comprises a first NFC antenna and a second NFC antenna, wherein the first NFC antenna forms a first loop of the antenna arrangement and wherein the second NFC antenna forms a second loop of the antenna arrangement
504 providing the NFC device with a first transmitter operatively coupled to the first NFC antenna, wherein the first transmitter is configured to feed said first NFC antenna
506 providing the NFC device with a second transmitter operatively coupled to the second NFC antenna, wherein the second transmitter is configured to feed said second NFC antenna
600 NFC device operating in a first operating state
602 first NFC antenna
604 second NFC antenna
606 first transmitter
608 ground
610 second transmitter
612 ground
614 NFC device operating in a second operating state
700 antenna arrangement performance in the first operating state
702 antenna arrangement performance in the second operating state
800 magnetic field measurements in the first operating state
802 first NFC antenna
804 second NFC antenna
806 first transmitter
808 ground
810 measurement area
812 magnetic field measurements in the second operating state
900 example implementation of an NFC device
902 NFC reader IC
904 matching circuit
906 NFC antenna
1000 practical implementation of an NFC device
1002 NFC reader IC
1004 matching circuit
1006 NFC antenna
1008 NFC antenna

1-15. (canceled)

16. A near field communication (NFC) device, comprising:
control circuitry;
a concentric antenna arrangement comprising a first NFC antenna coupled to the control circuitry and a second NFC antenna coupled to the control circuitry, wherein the first NFC antenna forms an outer loop of the concentric antenna arrangement and wherein the second NFC antenna forms an inner loop of the concentric antenna arrangement;
wherein the device is configured to switch between two operating states:
a first operating state in which the device is configured for communication with an external device using the concentric antenna arrangement and the control circuitry is configured to drive the first antenna and the second antenna with signals configured to constructively interfere at a center of the concentric antenna arrangement; and
a second operating state in which the device is configured to wirelessly charge an external device using the concentric antenna arrangement and the control circuitry is configured to drive the first antenna and the second antenna with signals configured to destructively interfere at a center of the concentric antenna arrangement.

17. The NFC device of claim 16, wherein the first NFC antenna is physically separated from the second NFC antenna.

18. The NFC device of claim 16, wherein the first NFC antenna and the second NFC antenna are single-ended antennas.

19. The NFC device of claim 16, wherein:
in the first operating state, the control circuitry feeds the first NFC antenna with a first signal and the second transmitter feeds the second NFC antenna with a second signal, wherein a phase of the first signal is substantially the same as a phase of the second signal;
in the second operating state, the control circuitry feeds the first NFC antenna with a third signal and the second transmitter feeds the second NFC antenna with a fourth signal, wherein a phase of the third signal is substantially different from a phase of the fourth signal.

20. The NFC device of claim 19, wherein the difference between the phase of the third signal and the phase of the fourth signal is 180 degrees or approximately 180 degrees.

21. The NFC device of claim 16, wherein the control circuitry includes wireless charging circuitry coupled to the concentric antenna arrangement.

22. The NFC of claim 21, wherein the wireless charging circuitry is configured for compatibility with a Qi wireless charging protocol.

23. A method comprising:
operatively coupling control circuitry of a near field communication device (NFC) device to a concentric antenna arrangement comprising a first NFC antenna and a second NFC antenna, wherein the first NFC antenna forms an outer loop of the concentric antenna arrangement and the second NFC antenna forms an inner loop of the concentric antenna arrangement;
during a first time period, operating the NFC device in a first operating state in which the device is configured for communication with an external device using the concentric antenna arrangement and the control circuitry is configured to drive the first antenna and the second antenna with signals configured to constructively interfere at a center of the concentric antenna arrangement; and
during a second time period, operating the NFC device in a second operating state in which the device is configured to wirelessly charge an external device using the concentric antenna arrangement and the control circuitry is configured to drive the first antenna and the second antenna with signals configured to destructively interfere at a center of the concentric antenna arrangement.

24. The method of claim 23, wherein the first NFC antenna is physically separated from the second NFC antenna.

25. The method of claim 23, wherein the first NFC antenna and the second NFC antenna are single-ended antennas.

26. The method of claim 23, further comprising configuring the NFC device to operate in a first operating state and in a second operating state, wherein:
in the first operating state, the control circuitry feeds the first NFC antenna with a first signal and the second transmitter feeds the second NFC antenna with a second signal, wherein the phase of the first signal is substantially the same as the phase of the second signal;
in the second operating state, the control circuitry feeds the first NFC antenna with a third signal and the control circuitry feeds the second NFC antenna with a fourth signal, wherein the phase of the third signal is substantially different from the phase of the fourth signal.

27. The method of claim 23, wherein the control circuitry further comprises wireless charging circuitry coupled to the concentric antenna arrangement.

28. The NFC of claim 23, wherein the wireless charging circuitry is configured for compatibility with a Qi wireless charging protocol.
